(19) United States
(12) Patent Application Publication
(10) Pub. No.: US 2026/0211814 A1
(43) Pub. Date: Jul. 23, 2026

(54) OPERATION BASED MULTI-LEVEL CACHING

(71) Applicant: Dell Products L.P., Round Rock, TX (US)

(72) Inventors: Viral Kirtikumar Mehta, Pune (IN); Rohit K Chawla, Scotch Plains, NJ (US); Neha Ramchandra Naik, Fairview, PA (US)

(21) Appl. No.: 19/035,558

(22) Filed: Jan. 23, 2025

(51) Int. Cl. G06F 12/0811; G06F 12/0891; G06F 16/172

(52) U.S. Cl. CPC G06F 12/0811; G06F 12/0891; G06F 16/172

(57) ABSTRACT

A method for operation based multi-level caching includes: receiving a request, in which the request is received for a data item; analyzing the request to identify an operation that is specified in the request and the data item; making a first determination that an inode of the data item is cached to memory previously; making a second determination that the inode is currently cached to the memory; identifying a first cache level in the memory that the inode was previously cached to; making a third determination that the first cache level is not correct; making a fourth determination that an inode eviction in a second cache level is needed; evicting a second inode of a second data item from the second cache level; and promoting the inode from the first cache level to the second cache level to cache the inode to the second cache level.

### BACKGROUND

Computing devices may include any number of internal components such as processors, memory, and persistent storage. Computing resources associated with (e.g., used by) each of these internal components may be used to generate, store, and backup data. Such utilization of computing resources may affect the overall performance of the computing devices.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1.1 shows a diagram of a system in accordance with one or more embodiments disclosed herein.

FIG. 1.2 shows an example cache insertion scenario in accordance with one or more embodiments disclosed herein.

FIG. 1.3 shows an example cache eviction scenario in accordance with one or more embodiments disclosed herein.

FIG. 2 shows a method for operation based multi-level caching in accordance with one or more embodiments disclosed herein.

FIG. 3 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, when dealing with a limited cache size (e.g., of a computing device) and a large number of elements (e.g., data such as files and folders, data items, data chunks, etc.) to cache, choosing an effective cache eviction model/algorithm becomes a crucial task. In the context of file system (e.g., a DataDomain file system) index node (inode) caching, choosing an effective cache eviction model becomes even more crucial. Inode caches (or inodes) store metadata with respect to files (e.g., an access control list of a file, an identifier of the file, an identifier of a parent folder containing the file, a size of the file, an offset for data that is stored in the file, a timestamp indicating when the file was generated, an ownership detail of the file, a tag of the file indicating a confidentiality status of the file, etc.) to improve file access performance. However, when the cache (of the computing device) reaches its capacity (or capacity limit), a corresponding entity (e.g., a module, an engine, a file system, etc.) of the computing device may need to identify inodes that need to be evicted.

Currently, various cache eviction approaches/policies exist (e.g., the Least Recently Used (LRU) cache approach, the Least Frequently Used (LFU) cache approach, the First-In-First-Out (FIFO) cache approach, etc.); however, each of these conventional cache eviction approaches has its own limitations. For example, none of the conventional cache eviction approaches uses/considers the context/reasoning behind an element (e.g., a data item, a file, etc.) that is being cached or was cached (e.g., for which operation the element was cached). As yet another example, each of the conventional cache eviction approaches uses multiple lists to promote or demote an element from one list to another by employing additional models.

From a different perspective, in a file system (e.g., a third extended file system (ext3), a fourth extended file system (ext4), a new technology file system (NTFS), etc.), inodes serve as essential data structures that store metadata about files and file directories (e.g., file system metadata). When a file is accessed (such as read or written) (e.g., upon receiving a request from a user of a computing device) for the first time, an inode of the file may be cached in memory (e.g., of the computing device), in which the size of the inode cache is directly tied to available memory on the computing device. This initial caching (of the file) may optimize subsequent read/write operations associated with the file, reducing the need for repeatedly fetching inodes from a disk (e.g., a hard disk drive (HDD), a solid-state drive (SSD), etc.) or any high-latency stable storage.

Further, because cache (e.g., a hardware component and/or a software component that is used to store data temporarily in a computing device/environment) has finite capacity and when the cache is full (or is at full capacity), some elements may need to be evicted from the cache. To do that, a corresponding entity (of the computing device) may need to traverse a large number of cache entries to decide/identify elements to be evicted. For example, the entity may traverse a hash table (located in memory) that maintains/hosts cached inodes, in which older (or less frequently accessed) inodes may be evicted (from the cache, as part of the memory) to make space for newer inodes to cache.

However, traversing the hash table causes drawbacks when operations/functions like “read directory (readdir)” are performed, in which related directories are scanned to list their contents (e.g., files). For example, in scenarios where multiple “readdir” operations are performed to analyze thousands of files (across different directories) may rapidly warm up the cache by evicting frequently accessed cache entries and, as the cache fills, cache eviction may occur more frequently because of the influx of inode accesses. Further, the traversal overhead (associated with traversing the hash table) may exacerbate the issue towards impacting the overall performance of a corresponding computing device.

For at least the reasons discussed above and without requiring resource-intensive efforts (e.g., time, engineering, etc.), a fundamentally different approach/framework is needed (e.g., an approach for an improved inode cache management by considering related file system operations that caused an element to be cached in memory).

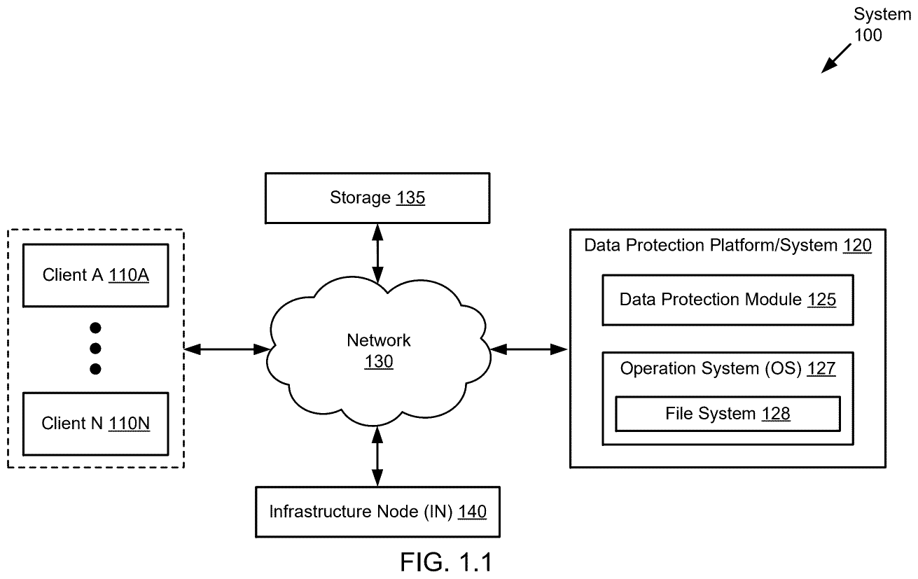

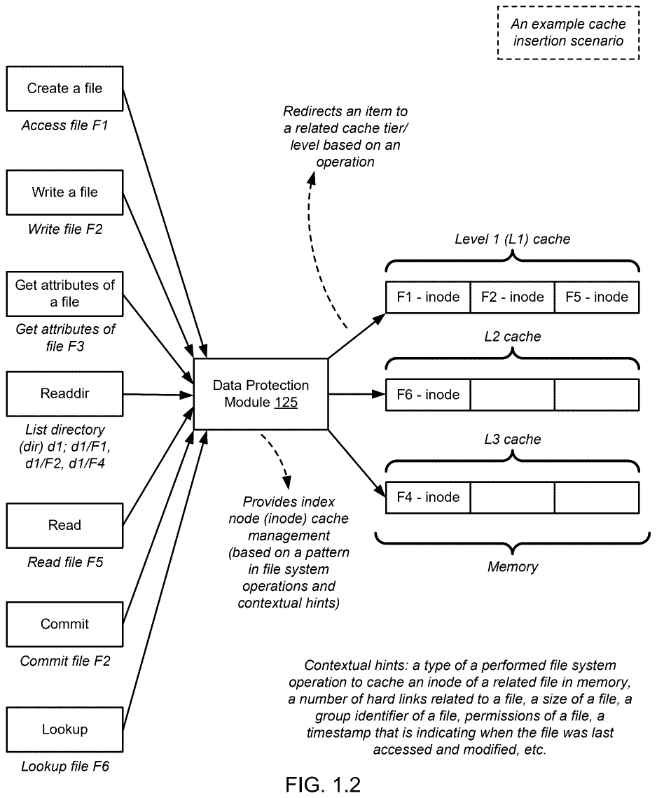

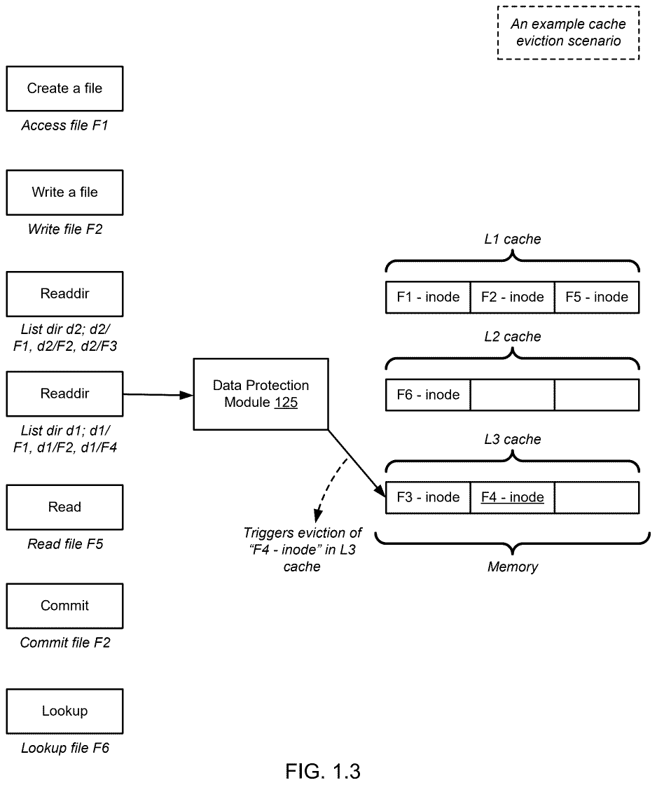

Embodiments disclosed herein relate to methods and systems to manage operation (e.g., file system operation) based multi-level caching (e.g., in a data protection system/platform). As a result of the processes discussed below, one or more embodiments disclosed herein advantageously ensure that: (i) the framework provides an improved inode cache management; (ii) an element (e.g., a cache entry element) is directly promoted or demoted (between different cache levels, see e.g., FIG. 1.2) based on a file system operation (e.g., a file access operation, a file read operation, etc., see FIG. 1.2); and/or (iii) the framework can be used for different workloads (e.g., backup workloads, batch workloads, transactional workloads, mission-critical workloads, etc.) for a better user experience.

The following describes various embodiments disclosed herein.

FIG. 1.1 shows a diagram of a system (100) in accordance with one or more embodiments disclosed herein. The system (100) includes any number of clients (e.g., Client A (110A), Client N (110N), etc.), a storage (135), an infrastructure node (IN) (140), a data protection platform/system (e.g., a DataDomain system) (120), and a network (130). The system (100) may include additional, fewer, and/or different components without departing from the scope of the embodiments disclosed herein. Each component may be operably/operatively connected to any of the other components via any combination of wired and/or wireless connections. Each component illustrated in FIG. 1.1 is discussed below.

In one or more embodiments, the clients (e.g., 110A, 110N, etc.), the storage (135), the IN (140), the data protection platform (120), and the network (130) may be (or may include) physical hardware or logical devices, as discussed below. While FIG. 1.1 shows a specific configuration of the system (100), other configurations may be used without departing from the scope of the embodiments disclosed herein. For example, although the clients (e.g., 110A, 110N, etc.) and the IN (140) are shown to be operatively connected through a communication network (e.g., 130), the clients (e.g., 110A, 110N, etc.) and the IN (140) may be directly connected (e.g., without an intervening communication network).

Further, the functioning of the clients (e.g., 110A, 110N, etc.) and the IN (140) is not dependent upon the functioning and/or existence of the other components (e.g., devices) in the system (100). Rather, the clients and the IN may function independently and perform operations locally that do not require communication with other components. Accordingly, embodiments disclosed herein should not be limited to the configuration of components shown in FIG. 1.1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

As used herein, a “volume” may be analogous to a logical unit number in a storage area network (SAN), in which a volume may be a subset of the storage's (135) capacity presented by a storage node of the storage as a local block device. A volume's data may be evenly distributed across all storage resources of the storage (135), for example, according to a data layout selected for the storage (135).

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

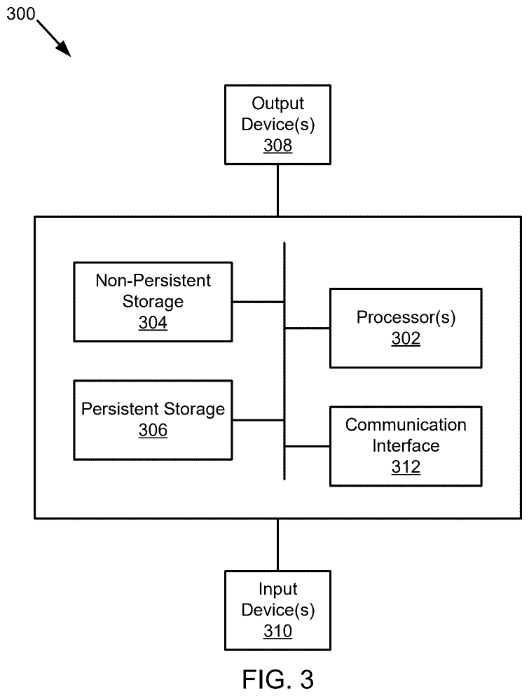

In one or more embodiments, the system (100) may be a distributed system (e.g., a data processing environment) and may deliver at least computing power (e.g., real-time (on the order of milliseconds (ms) or less) network monitoring, server virtualization, data deduplication, etc.), storage capacity (e.g., to store encrypted data across storage nodes (not shown) of the storage (135)), and data protection (e.g., software-defined data protection, disaster recovery, etc.) as a service to users (e.g., people) of clients (e.g., 110A, 110N, etc.). For example, the system may be configured to organize unbounded, continuously generated data into a data stream. The system (100) may also represent a comprehensive middleware layer executing on computing devices (e.g., 300, FIG. 3) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users'site using the clients (e.g., 110A, 110N, etc.)) and other computations remotely (e.g., away from the users'site using the IN (140)) from the users. By doing so, the users may utilize different computing devices (e.g., 300, FIG. 3) that have different quantities of computing resources (e.g., processing cycles, memory, storage, etc.) while still being afforded consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as a universal serial bus (USB) device), etc.

In one or more embodiments, a client (e.g., 110A, 110N, etc.) may include functionality to, e.g.,: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., the IN (140)), store, or otherwise utilize captured sensor data (and/or any other type and/or quantity of data), and (iv) provide surveillance services (e.g., determining object-level information, performing face recognition, etc.) for scenes (e.g., a physical region of space). One of ordinary skill will appreciate that the client may perform other functionalities without departing from the scope of the embodiments disclosed herein.

In one or more embodiments, the clients (e.g., 110A, 110N, etc.) may be geographically distributed devices (e.g., user devices, front-end devices, etc.) and may have relatively restricted hardware and/or software resources when compared to the IN (140). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene/environment), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, the clients (e.g., 110A, 110N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110N, etc.) may correspond to computing devices that one or more users use to interact with one or more components of the system (100).

In one or more embodiments, a client (e.g., 110A, 110N, etc.) may represent a physical appliance or a computing device operated by one or more individuals of (or employed by) an organization. Examples of said individual(s) may include, but not limited to, any organization executive(s) (e.g., chief executive officer (CEO), chief financial officer (CFO), etc.), and any employee(s) in the accounting/finance team of the organization (e.g., a collector person). Further, the organization may refer to any enterprise at least engaged in for-profit commercial, industrial, or professional activities.

In one or more embodiments, a client (e.g., 110A, 110N, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110N, etc.). In one or more embodiments, applications may be logical entities executed using computing resources of a client. For example, applications may be implemented as computer instructions stored on persistent storage of the client that when executed by the processor(s) of the client, cause the client to provide the functionality of the applications described throughout the application.

In one or more embodiments, while performing, for example, one or more operations requested by a user, applications installed on a client (e.g., 110A, 110N, etc.) may include functionality to request and use physical and logical resources of the client. Applications may also include functionality to use data stored in storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110N, etc.) may utilize, rely on, or otherwise cooperate with the IN (140) and/or the storage (135). For example, the clients may issue requests to the IN to receive responses and interact with various components of the IN. The clients may also request data from and/or send data to the IN (for example, the clients may transmit information to the IN that allows the IN to perform computations, the results of which are used by the clients to provide services to the users). As yet another example, the clients may utilize computer-implemented services provided by the IN. When the clients interact with the IN, data that is relevant to the clients may be stored (temporarily or permanently) in the IN.

In one or more embodiments, a client (e.g., 110A, 110N, etc.) may be capable of, e.g.,: (i) collecting users'inputs, (ii) correlating collected users'inputs to the computer-implemented services to be provided to the users, (iii) communicating with the IN (140) and/or the storage (135) that perform computations necessary to provide the computer-implemented services, (iv) using the computations performed by, for example, the IN to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a computation acceleration resource, an application-specific integrated circuit (ASIC), a digital signal processor for facilitating high speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): an HDD, an SSD, random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110N, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the embodiments disclosed herein.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface a client with external entities (e.g., the IN (140), the storage (135), etc.) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110N, etc.). For example, when utilizing remote direct memory access (RDMA) to access data on another client, it may not be necessary to interact with the logical components of that client. Rather, when using RDMA, it may be possible for the networking resource to interact with the physical components of that client to retrieve and/or transmit data, thereby avoiding any higher-level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110N, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client, cause the client to provide the functionality of the hypervisor.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiments, Client A (110A) may have 16 gigabytes (GB) of dynamic RAM (DRAM) and 1 CPU with 12 cores, whereas Client N (110N) may have 8 GB of PMEM and 1 CPU with 16 cores. Other different computational capabilities of the clients not listed above may also be considered without departing from the scope of the embodiments disclosed herein.

Further, in one or more embodiments, a client (e.g., 110A, 110N, etc.) may be implemented as a computing device (e.g., 300, FIG. 3). The computing device may be, for example, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110N, etc.) may be implemented as a logical device (e.g., a VM). The logical device may utilize the computing resources of any number of computing devices to provide the functionality of the client described throughout this application.

In one or more embodiments, users (e.g., customers, administrators, organization executives, etc.) may interact with (or operate) the clients (e.g., 110A, 110N, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing virtualization technology. In one or more embodiments, an administrator may be a user with permission (e.g., a user that has root-level access) to make changes to the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a graphical user interface (GUI) generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 300, FIG. 3) using functionalities of a display engine (not shown), in which the display engine is operatively connected to the computing device. The display engine may be implemented using hardware (or a hardware component), software (or a software component), or any combination thereof. The login screen may be displayed in any visual format that would allow the user to easily comprehend (e.g., read and parse) the listed information.

In one or more embodiments, the IN (140) may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, the IN (140) may include functionality to, e.g.,: (i) obtain (or receive) data (e.g., any type and/or quantity of input) from any source (and, if necessary, aggregate the data); (ii) perform complex analytics and analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to the storage for management of the data and/or for storage of the data (while pushing the data, the IN may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or machine learning (ML) models to perform cloud-based data processing); (vii) incorporate strategies (e.g., strategies to provide VDI capabilities) for remotely enhancing capabilities of the clients; (viii) provide robust security features (in conjunction with the data protection module (125)) to the clients and make sure that a minimum level of service is always provided to a user of a client; (ix) transmit the result(s) of the computing work performed (e.g., real-time business insights, equipment maintenance predictions, other actionable responses, etc.) to another IN (not shown) for review and/or other human interactions; (x) exchange data with other devices registered in/to the network (130) in order to, for example, participate in a collaborative workload placement (e.g., the node may split up a request (e.g., an operation, a task, an activity, etc.) with another IN, coordinating its efforts to complete the request more efficiently than if the IN had been responsible for completing the request); (xi) provide (in conjunction with the data protection module (125)) software-defined data protection for the clients (e.g., 110A, 110N, etc.); (xii) provide (in conjunction with the data protection module (125)) automated data discovery, protection, management, and recovery operations for the clients; (xiii) monitor operational states of the clients; (xiv) regularly back up (in conjunction with the data protection module (125)) configuration information of the clients to the storage (135); (xv) provide (e.g., via a broadcast, multicast, or unicast mechanism) information (e.g., a location identifier, the amount of available resources, etc.) associated with the IN to other INs of the system (100); (xvi) configure or control any mechanism that defines when, how, and what data to provide to the clients and/or to the storage; (xvii) provide data deduplication (in conjunction with the data protection module (125)); (xviii) orchestrate (in conjunction with the data protection module (125)) data protection through one or more GUIs; (xix) empower data owners (e.g., users of the clients) to perform self-service data backup and restore operations from their native applications (in conjunction with the data protection module (125)); (xx) ensure compliance and satisfy different types of service level objectives (SLOs) set by an administrator/user; (xxi) increase (in conjunction with the data protection module (125)) resiliency of an organization by enabling rapid recovery or cloud disaster recovery from cyber incidents; (xxii) provide operational simplicity, agility, and flexibility for physical, virtual, and cloud-native environments; (xxiii) consolidate (in conjunction with the data protection module (125)) multiple data process or protection requests (received from, for example, clients) so that duplicative operations (which may not be useful for restoration purposes) are not generated; (xxiv) initiate multiple data process or protection operations in parallel (e.g., an IN may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the IN (140) may communicate with, for example, the storage (135) and/or other storage devices in the system (100).

As described above, the IN (140) may be capable of providing a range of functionalities/services to the users of the clients (e.g., 110A, 110N, etc.). However, not all users may be allowed to receive all the services. To manage the services provided to the users of the clients, a system (e.g., a service manager) in accordance with embodiments disclosed herein may manage the operation of a network (e.g., 130), in which the clients are operably connected to the IN. Specifically, the service manager (i) may identify services to be provided by the IN (for example, based on the number of users using the clients) and (ii) may limit communications of the clients to receive IN provided services.

For example, the priority (e.g., the user access level) of a user may be used to determine how to manage computing resources of the IN (140) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g. a non-privileged user, a user with a user access level/tier of 4/10). In such a scenario, the user level of that user may indicate that certain ports (of the subcomponents of the network (130) corresponding to communication protocols such as the TCP, the UDP, etc.) are to be opened, other ports are to be blocked/disabled so that (i) certain services are to be provided to the user by the IN (140) (e.g., while the computing resources of the IN may be capable of providing/performing any number of remote computer-implemented services, they may be limited in providing some of the services over the network (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110N, etc.) may be granularly configured without modifying the operation(s) of the clients and (ii) the overhead for managing the services of the clients may be reduced by not requiring modification of the operation(s) of the clients directly.

In contrast, a second user may be determined to be a high priority user (e.g., a privileged user, a user with a user access level of 9/10). In such a case, the user level of that user may indicate that more ports are to be opened than were for the first user so that (i) the IN (140) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

As used herein, a “policy” is a collection of information, such as a backup policy or other data protection policy, that includes, for example (but not limited to): identity of source data that is to be protected, backup schedule and retention requirements for backed up source data, identity of a service level agreement (SLA) (or a rule) that applies to source data, identity of a target device where source data is to be stored, etc.

As used herein, the term “backup” is intended to be broad in scope. In this manner, example backups (in connection with which embodiments disclosed herein) may be employed include (but not limited to): full backups, partial backups, clones, snapshots, incremental backups, differential backups, etc.

As used herein, “data retention” is a period of time, with a definite start and end, within which the data should be retained in storage (e.g., 135). For example, a set of user requirements and/or technical considerations (e.g., security considerations, performance considerations, etc.) of a data center may be used to generate a data retention policy specifying that user data should be retained in the storage for seven years.

As used herein, a “rule” is a guideline used by an SLA component to select a particular target device (or target devices), based on the ability of the target device to meet requirements imposed by the SLA. For example, a rule may specify that an HDD having a particular performance parameter should be used as the target device. A target device selected by the SLA component may be identified as part of a backup policy or other data protection policy.

As used herein, an “SLA” between, for example, a vendor and a user may specify one or more user performance requirements (that define, for example, a target device to be chosen dynamically during, and as part of, a data protection process), for example (but not limited to): how many copies should be made of source data, latency requirements, data availability requirements, recovery point objective (RPO) requirements, recovery time objective (RTO) requirements, etc. In most cases, the user may be agnostic as to which particular target devices are used, as long as the user performance requirements are satisfied.

In one or more embodiments, data protection policies used to protect massive amounts of data may require a certain level of intelligence to infer SLAs of a user and provide ease of implementing data protection by reducing manual effort as much as possible to meet user expectations (or user demands). Further, a data protection policy may be defined and implemented to determine target device(s) that are best suited to meet user SLAs (that are defined within the policy). In some cases, user SLAs may be assigned to particular data protection policies for different types of data protection workloads.

In one or more embodiments, the wrong (or sub-optimal) selection of a target device may (i) result in generating an over-utilized or under-utilized target device and (ii) unnecessarily delay a backup (or replication) operation window.

Further, while a single IN (e.g., 140) is considered above, the term “node” includes any collection of systems or sub-systems that individually or jointly execute a set, or multiple sets, of instructions to provide one or more computer-implemented services. For example, a single IN/server/host may provide a computer-implemented service on its own (i.e., independently) while multiple other nodes may provide a second computer-implemented service cooperatively (e.g., each of the multiple other nodes may provide similar and or different services that form the cooperatively provided service).

As described above, the IN (140) may provide any quantity and any type of computer-implemented services. To provide computer-implemented services, the IN may be a heterogeneous set, including a collection of physical components/resources (discussed above) configured to perform operations of the node and/or otherwise execute a collection of logical components/resources (discussed above) of the node.

In one or more embodiments, the IN (140) may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

One of ordinary skill will appreciate that the IN (140) may perform other functionalities without departing from the scope of the embodiments disclosed herein.

In one or more embodiments, the IN (140) may be implemented as a computing device (e.g., 300, FIG. 3). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the IN described throughout the application.

Alternatively, in one or more embodiments, similar to a client (e.g., 110A, 110N, etc.), the IN (140) may also be implemented as a logical device.

In one or more embodiments, the data protection system (120) hosts, at least, the data protection module (125) and an operating system (127). The data protection module (125) and the operating system (127) may be physical or logical entities, as discussed below.

Referring to FIG. 1.1, the data protection module (125) may be part of the data protection system (120), may execute as a standalone computing device, or may execute on any of the components of the system (100). For example, the data protection module (125) may be part of the IN (140) or another component of the system (100).

In one or more embodiments, as being a physical computing device or a logical computing device, the data protection module (125) may include functionality to, at least:
(i) provide software-defined data protection (e.g., protecting data against loss); (ii) provide automated data discovery, protection, management, and recovery operations (e.g., to reconstruct data following loss) in on-premises; (iii) provide data deduplication; (iv) orchestrate centralized data protection through its GUI (e.g., by its GUI, the module may provide users an item level view of backups); (v) empower data owners (e.g., users) to perform self-service data backup and restore operations from their native applications; (vi) ensure compliance and satisfy different types of SLOs; (vii) enable virtualized and cloud deployments, including automated data discovery, protection, management, and recovery operations for in-cloud workloads; (viii) enable data discovery, protection, management, and recovery operations for cloud-native workloads (e.g., an application that was designed to reside in a cloud environment) across multiple cloud environments; (ix) simplify VM image backups of a VM with near-zero impact on the VM; (x) streamline data protection for applications and/or containers (e.g., Kubernetes® containers); (xi) increase resiliency of an organization by enabling rapid recovery or cloud disaster recovery from cyber incidents; (xii) provide long-term data retention (in conjunction with the storage (135)); (xiii) provide dynamic NAS backup and recovery; and/or (xiv) provide operational simplicity, agility, and flexibility for physical, virtual, and cloud-native information technology (IT) environments.

In one or more embodiments, the data protection module (125) may further include functionality to, at least: (i) provide inode cache management (see FIG. 1.2-1.3); (ii) delete an entire directory tree; (iii) recover an accidental deletion of a directory tree (e.g., by performing a rollback operation); (iv) copy an entire directory tree from one namespace (e.g., a source, a first file system, etc.) to another namespace (e.g., a target, a second file system, etc.); (v) move an entire directory tree from one namespace (e.g., a source, a first file system, etc.) to another namespace (e.g., a target, a second file system, etc.); and/or (vi) prevent traversing an entire directory (to perform a deletion process, a copying process, or a moving process) for not consuming a lot of time and computing resources (while performing those processes).

As discussed above, the data protection module (125) may provide data protection (e.g., data backup, data management, data restore, etc.) services to the IN (140) (or any other component of the system (100)). The data protection services may initiate (e.g., instantiate, execute, etc.) generation and storage of backups (e.g., block-based backups, file-based backups (e.g., a file-based backup is a backup of a file system (e.g., 128) that has been updated, modified, and/or otherwise accessed by the IN (140)), etc.) in the storage (135). The data protection services may also include restoration of the IN (140) (or any other component of the system (100)) to a restoration host (e.g., a secondary storage system, not shown) using the backups stored (temporarily or permanently) in the storage (135) and in accordance with restoration procedures initiated by one or more entities in the system (100).

As being a separate computing device that coordinates backups and restorations (and either includes or communicates with a backup storage (e.g., 135) for storing a completed backup and other data), the data protection module (125) may provide data protection services to the IN (140) (or any other component of the system (100)) by orchestrating (or scheduling): (i) generation of backups of the IN (140) (e.g., generation of backups of assets (e.g., files, folders, etc.) associated with the IN); (ii) storage of the generated backups of the IN (140) in the storage (135); (iii) consolidation of one or more backup requests to reduce (or to prevent) generation of backups that are not useful for restoration purposes; and/or (iv) restoration of the IN (140) to previous states using backups stored in the storage (135). To provide the aforementioned services, the data protection module (125) may include functionality to generate and issue instructions to any other component of the system (100). The data protection module (125) may also generate instructions in response to data protection requests from other entities/devices.

The data protection module (125) may generate such instructions in accordance with backup schedules that specify when backups are to be generated. In one or more embodiments, a backup schedule may lay out specific points in time for a backup process to be performed. Additionally, these backup schedules may be configured based on a user's RPO.

In one or more embodiments, the data protection module (125) may generate and provide to the storage (135) backup data, backup metadata, as well as any other data that is produced by the data protection module (125) in the process of performing a backup based on backup policies implemented by the data protection module (125). The backup policies may specify a schedule in which assets associated with the IN (140) and/or clients (e.g., 110A, 110N, etc.) are to be backed up. The backups may take the form of either a full or incremental backup as well as any other type of backup.

For example, the data protection module (125) may be triggered to generate a backup along with backup metadata and provide the backup and its metadata to the storage (135) in response to a backup policy. Alternatively, backup, and backup metadata may be generated by the data protection module (125) and provided to the storage (135) in response to a backup request triggered by a client (e.g., 110A) or a user of the client.

As discussed above, the data protection module (125) may restore backup metadata and backup data stored in the storage (135). When the data protection module (125) (or other equivalent component of the system (100)) receives a request for a restoration of a backup (e.g., at a later time after performing the backup), the data protection module (125) (or the equivalent component) retrieves the metadata and data stored in the storage (135) and restores the data (without reorganizing) to its original location in, for example, the IN (140). Alternatively, in one or more embodiments disclosed herein, the data in the backup may be restored to a file system located in a different IN/host than where it was originally restored as directed by a user, administrator, or other party that requested the restoration. Other methods for restoring the backup may be used and the embodiments disclosed herein are not limited to those described above.

Further, the data protection module (125) includes functionality for generating a file system backup and a file system metadata backup associated with data of the file system (128) (e.g., file system data), in which the file system backup may be generated by copying at least the file system data and storing the copy in the storage (135). Similarly, the file system metadata backup may be generated by copying at least the metadata and storing the copy in the storage (135), in which the metadata backup may be stored as files that are separate from the file system backup.

In one or more embodiments, the data protection module (125) may obtain a status of a backup (e.g., a block-based backup (BBB)) from the storage (135). The status of the BBB may specify information such as: (i) whether the BBB was successful and whether the backup was completed within a BBB window (e.g., 100% of the BBB was completed within the BBB window), or (ii) whether the BBB was unsuccessful and how much of the BBB was not completed within the BBB window (e.g., 70% of the BBB was completed and 30% of the BBB was not completed). In one or more embodiments, the BBB window may be a period of time, with a definite start and end, within which a BBB is set to be completed.

In one or more embodiments, the data protection module (125) may include a backup monitoring service for monitoring the status of a backup (e.g., a BBB). The backup monitoring service may be a computer program that may be executed on the underlying hardware of the data protection module (125). The backup monitoring service may also be designed and configured to facilitate remote access to check the status of and/or manipulate locally stored data during the BBB. Further, the backup monitoring service may include functionality to control remote procedure calls (e.g., application programming interface (API) calls) that access and manipulate any granularity of the locally stored data during the BBB.

As discussed above, the data protection module (125) may be configured to orchestrate a data restoration process (e.g., restoration of the IN (140) to a recovery node using backups stored in the storage (135)). For example, when a backup of the IN (140) is completed (at a first point-in-time) and then the IN (140) is failed, the data protection module (125) may initiate a restoration process (at a second point-in-time, which is later than the first point-in-time) to restore the IN. Based on initiating the data restoration process, a user of Client A (110A) may select one or more assets to restore from the backup of the IN (140) via a GUI. In one or more embodiments, the data protection module (125) or Client A (110A) may provide the GUI to the user.

Continuing with the discussion of the example, once the user has selected the assets via the GUI, the data protection module (125) may make an API call to the storage (135) to access the selected assets in the backup. Based on receiving the API call from the data protection module (125), the storage (135) may allow the data protection module (135) to access the backup. The data protection module (125) may then read data of the selected assets from the backup. The data protection module (125) may then restore the selected assets to the recovery host in accordance with file system metadata associated with the selected assets.

Further, the data protection module (125) may include functionality to consolidate multiple restore requests (received from a user of a client) to prevent generation of duplicative restorations (e.g., of the IN (140)), in which preventing the generation of duplicative restorations may reduce a restoration window. In one or more embodiments, the restoration window may be a period of time, with a definite start and end, within which an asset restoration is set to be completed. Separately, the data protection module (125) may include functionality to initiate multiple restorations in parallel. For example, the data protection module (125) may host multiple restoration processes. Each of the multiple restoration processes may manage the initiation of a respective restoration. Each of the multiple restoration processes may operate concurrently to initiate multiple restorations.

One of ordinary skill will appreciate that the data protection module (125) may perform other functionalities without departing from the scope of the embodiments disclosed herein. The data protection module (125) may be implemented as a computing device using hardware (e.g., any number of integrated circuits for processing computer readable instructions), software (e.g., a computer program), or any combination thereof.

In one or more embodiments, the operating system (127) may refer to a computer program that may execute on the underlying hardware of the data protection system (120), which may be responsible for overseeing the data protection module's (125) operations. For example, the operating system (127) may include any program of executable instructions (or aggregation of programs of executable instructions) configured to manage and/or control the allocation and usage of hardware resources such as memory, processor time, disk space, and input/output devices, and provide an interface between such hardware resources and applications hosted by the operating system (127).

In one or more embodiments, at least in part, the operating system (127) may include functionality to: (i) support fundamental data protection system functions; (ii) schedule tasks; (iii) mediate interactivity between logical (i.e., software) and physical (i.e., hardware) data protection system subcomponents; (iv) allocate hardware or logical resources of the data protection system (120) as needed; and/or (v) execute or invoke other computer programs (e.g., the data protection module (125)) executing on the data protection system (120). One of ordinary skill will appreciate that the operating system (127) may perform other functionalities without departing from the scope of the embodiments described herein.

For example, the operating system (127) may facilitate access and interaction with locally stored information (e.g., application, user, and/or service data and metadata) by other computer program(s) executing on the data protection system (120). In facilitating said access and interaction, the operating system (127) may implement the file system (128). The file system (128) may refer to a physical file system (or file system implementation), which may reference a collection of subroutines concerned with the physical operation of one or more physical storage devices(s) (e.g., 135). The file system (128), in this respect, may be concerned with the physical operation of at least a subset of the storage (135). Accordingly, the file system (128) may host storage device drivers (or firmware) to process requested file system operations from other computing devices (e.g., 125, 140, etc.). Device drivers may enable the file system (128) to manipulate physical storage, in the form of disk blocks and/or file regions for example, as appropriate.

As used herein, a “file system” is a method that an OS (e.g., Microsoft® Windows, Apple® MacOS, etc.) is used to control how data is named, stored, and retrieved. For example, once a user has logged into a computing device (e.g., 300, FIG. 3), the OS of that computing device uses the file system of that computing device to retrieve one or more applications to start performing one or more operations (e.g., functions, tasks, activities, jobs, etc.). As yet another example, a file system may divide a volume (e.g., a logical drive) into a fixed group of bytes to generate one or more blocks of the volume.

In one or more embodiments, the file system (128) may provide, at least, user login verification services, storage of directory information, user access management services, one or more APIs, certificate services, file system metadata management services, and/or domain management services. Other services may be provided by the file system (128) without departing from the scope of the embodiments disclosed herein. The file system (128) is implemented as computer instructions, e.g., computer code, stored on persistent storage (of the data protection system (120)) that when executed by a processor(s) of the data protection system, the data protection system provides the functionalities of the file system (128) described throughout this application.

In the embodiments of the present disclosure, the file system (128) is demonstrated as a part of the data protection system (120); however, embodiments disclosed herein are not limited as such. A second file system (not shown) may be a part of any other computing device (e.g., 140) executing on the system (100). For example, the IN (140) may generate application/user data to be utilized for servicing of users (of the clients). The application data may be organized in accordance with the second file system. Similar to the file system (128), the second file system (e.g., a log-structured file system) may include any number of files and/or folders (e.g., used by the IN (140)) organized into directories, in which the directories may include paths for accessing the files. The second file system may be stored in a container stored in persistent storage of the IN (140).

In one or more embodiments, file system data (e.g., data that is associated with the file system (128)) may include data for one or more files. Each file system data (also referred to as file data) may correspond to a file in the file system (128). The file data may further include data tags, in which the data tags may be associated with a storage format of the file data. For example, the file data may be stored in a common data streaming format (CDSF), in which the CDSF may be a format that includes data tags corresponding to a portion of data and may specify a file-based backup corresponding to the portion of data. In this manner, the file data may include, at least: (i) the data of the files and/or file system and (ii) the data tags that specify metadata of one or more portions of the file data.

As used herein, “file system metadata” may reflect (i) information descriptive of each file managed by the file system (128) and (ii) information regarding to an organizational structure of the file system (128). Examples of file system metadata, descriptive of any given asset, may include/specify (but not limited to): an identifier of an asset (e.g., “file_1”, “folder_1”, etc.); an identifier of a parent folder containing an asset (e.g., an identifier of a parent folder may be “folder_3/file_2”, which specifies that “folder_3” contains “file_2”); an offset for data of an asset stored in a virtual hard disk (VHDX) (e.g., an offset for data of an asset may be a pointer that points to one or more blocks of a VHDX file that stores the data); a read/write attribute of an asset (e.g., Asset A is read-only, Asset B is hidden, etc.); a type of an asset reflecting a format through which the asset may be encoded for storage (e.g., a “.pdf” file, a “.doc” file, etc.); a size (e.g., expressed in bytes) of an asset (e.g., a size of an asset may specify how much storage space is consumed by the asset); a content of an asset (e.g., a legal document, an engineering design document, etc.); a generation timestamp encoding a date and/or time on which an asset had been generated (or first introduced); a modification timestamp encoding a date and/or time on which an asset had last been modified; any access permissions/levels associated with an asset (e.g., an access control list (ACL) of an asset that defines which user has access to the asset (e.g., the ACL of the asset may specify that a user with a user access level of 7 or above can access the asset)); an identifier of an owner (or a user) responsible for generating an asset; a hash value of file data; a checksum value of the file data; a header size; a directory service associated with an asset; a number of assets; an asset path specifying a location (within the file system (128)) (e.g., a/b/c/t.txt); a data block identifier associated with a data block of an asset; etc.

For example, consider a scenario in which file system metadata specifies (i) Folder A, (ii) File B, (iii) File A, (iv) Folder C, (v) Folder B, (vi) Folder D, (vii) File X, (viii) File Y, and (ix) File Z. In this scenario, each of the aforementioned contents of the file system metadata may not be currently configured in a hierarchical manner. Said another way, the contents of the file system metadata may be arranged in a random order. To this end, the operating system (127) may reorder the contents of the file system metadata to obtain a hierarchical structure (e.g., a file system hierarchy/index that specifies which folder contains which folder and/or which folder contains which file).

After the reordering, the file system hierarchy may also specify an access level of each asset (in which an access level of an asset specifies which user can view that asset (based on the user's access level)). For example, the file system hierarchy may specify that (i) Folder B contains Folder D (e.g., Folder B is a parent folder of Folder D) and (ii) the access level of Folder B is 4 and the access level of Folder D is 5. In this example, to be able to view Folder D, a user should have a user access level of at least 5 or higher.

In one or more embodiments, file system metadata may be stored in persistent storage of the data protection system (120). Information included in that persistent storage may be determined (by the data protection module (125)) as a normal function of the file system (128), in which this information may also be determined as a part of, for example, a metadata-based backup, or other functions requested by the IN (140) (or other components of the system (100)). In one or more embodiments, the information may be used for determining an asset that is associated with a user, producing estimates of the size of the asset, determining where the asset is located, and/or other functions (that need to be performed by the data protection module) such as performing a backup.

Turning now to the storage (135), the storage (135) may provide long-term, durable, high read/write throughput data storage/protection with near-infinite scale and low-cost. The storage (135) may be a fully managed cloud/remote (or local) storage (e.g., pluggable storage, object storage, block storage, file system storage, data stream storage, Web servers, unstructured storage, etc.) that acts as a shared storage/memory resource that is functional to store unstructured and/or structured data. For example, the storage (135) may store data (e.g., backup data; file system metadata; assets; rules and/or procedures for performing backups of the IN (140); etc.). Further, the storage (135) may also occupy a portion of a physical storage/memory device or, alternatively, may span across multiple physical storage/memory devices. The storage (135) may include other and/or additional functionalities without departing from embodiments disclosed herein.

In one or more embodiments, the storage (135) may be implemented using physical devices that provide data storage services (e.g., storing data and providing copies of previously stored data). The devices that provide data storage services may include hardware devices and/or logical devices. For example, the storage (135) may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the storage (135) may include a memory device (e.g., a dual in-line memory device), in which data is stored and from which copies of previously stored data are provided. As yet another example, the storage (135) may include a persistent storage device (e.g., an SSD), in which data is stored and from which copies of previously stored data is provided. As yet another example, the storage (135) may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the storage (135) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the storage (135) may store/log/record unstructured and/or structured data that may include (or specify), for example (but not limited to): an identifier of a user/customer; a backup policy/practice; telemetry data including past and present device usage of one or more computing devices; data for execution of applications/services including IN applications and associated end-points; corpuses of annotated data used to build/generate and train processing classifiers for trained ML models; linear, non-linear, and/or ML model parameters; data tags; an identifier of a sensor; a product identifier of a client (e.g., 110A); a type of a client; historical sensor data/input (e.g., visual sensor data, audio sensor data, electromagnetic radiation sensor data, temperature sensor data, humidity sensor data, corrosion sensor data, etc., in the form of text, audio, video, touch, and/or motion) and its corresponding details; an identifier of a data item; a size of the data item; an identifier of a user (e.g., a unique string or combination of bits associated with a particular user) who initiated a backup (via a client); a distributed model identifier that uniquely identifies a distributed model; a user activity performed on a data item; a cumulative history of user/administrator activity records obtained over a prolonged period of time; a setting (and a version) of a mission critical application executing on the IN (140); configuration information associated with the data protection module (125) and/or the IN (140); a job detail of a job that has been initiated by the IN; a type of the job (e.g., a non-parallel processing job, a parallel processing job, an analytics job, etc.); information associated with a hardware resource set (discussed below) of the IN; a completion timestamp encoding a date and/or time reflective of the successful completion of a job; a time duration reflecting the length of time expended for executing and completing a job; a backup retention period associated with an asset (e.g., data item); a status of a job (e.g., how many jobs are still active, how many jobs are completed, etc.); a number of requests handled (in parallel) per minute (or per second, per hour, etc.) by the data protection system (120); a number of errors encountered when handling a job (e.g., a backup process); a documentation that shows how the data protection module (125) performs against an SLO and/or an SLA; a set of requests received by the IN (140); a set of responses provided (by the IN) to those requests; information regarding an administrator (e.g., a high priority trusted administrator, a low priority trusted administrator, etc.) related to a job; tier/level information of a user (e.g., a high-privileged user, a low-privileged user, etc.); etc.

In one or more embodiments, information associated with a hardware resource set (e.g., including at least resource related parameters) may specify, for example (but not limited to): a configurable CPU option (e.g., a valid/legitimate vCPU count for the IN (140)), a configurable network resource option (e.g., enabling/disabling single-root input/output virtualization (SR-IOV) for the IN (140)), a configurable memory option (e.g., maximum and minimum memory for the IN (140)), a configurable GPU option (e.g., allowable scheduling policy and/or virtual GPU (vGPU) count combinations for the IN (140)), a configurable DPU option (e.g., legitimacy of disabling inter-integrated circuit (I2C) for the IN (140)), a configurable storage space option (e.g., a list of disk cloning technologies across one or more INs in the system (100)), a configurable storage I/O option (e.g., a list of possible file system block sizes across all target file systems), a user type (e.g., a knowledge worker, a task worker with relatively low-end compute requirements, a high-end user that requires a rich multimedia experience, etc.), a network resource related template (e.g., a 10 GB/s BW with 20 ms latency quality of service (QoS) template), a DPU related template (e.g., a 1 GB/s BW vDPU with 1 GB vDPU frame buffer template), a GPU related template (e.g., a depth-first vGPU with 1 GB vGPU frame buffer template), a storage space related template (e.g., a 40 GB SSD storage template), a CPU related template (e.g., a 1 vCPU with 4 cores template), a memory resource related template (e.g., an 8 GB DRAM template), a vCPU count per analytics engine, a virtual NIC (vNIC) count per IN in the system (100), a wake on LAN support configuration (e.g., supported/enabled, not supported/disabled, etc.), a vGPU count per IN in the system (100), a type of a vGPU scheduling policy (e.g., a “fixed share” vGPU scheduling policy), a storage mode configuration (e.g., an enabled high-performance storage array mode), etc.

While the unstructured and/or structured data are illustrated as separate data structures and have been discussed as including a limited amount of specific information, any of the aforementioned data structures may be divided into any number of data structures, combined with any number of other data structures, and/or may include additional, less, and/or different information without departing from the scope of the embodiments disclosed herein.

Additionally, while illustrated as being stored in the storage (135), any of the aforementioned data structures may be stored in different locations (e.g., in persistent storage of other computing devices) and/or spanned across any number of computing devices without departing from the scope of the embodiments disclosed herein.

In one or more embodiments, the unstructured and/or structured data may be updated (automatically) by third-party systems (e.g., platforms, marketplaces, etc.) (provided by vendors) and/or by the administrators based on, for example, newer (e.g., updated) versions of external information. The unstructured and/or structured data may also be updated when, for example (but not limited to): a set of newer backup rules is received, an ongoing backup process is fully completed, a state of the data protection module (125) is changed, etc.

In the embodiments of the present disclosure, the storage (135) is demonstrated as a separate entity from the IN (140); however, embodiments disclosed herein are not limited as such. The storage (140) may be demonstrated as a part of the IN (e.g., as deployed to the IN (140)).

While the storage (135) has been illustrated and described as including a limited number and type of data, the storage (135) may store additional, less, and/or different data without departing from the scope of the embodiments disclosed herein. One of ordinary skill will appreciate that the storage (135) may perform other functionalities without departing from the scope of the embodiments disclosed herein.

In one or more embodiments, all, or a portion, of the components of the system (100) may be operably connected each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., the clients, the IN, the storage nodes, etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the clients and the IN through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

In one or more embodiments, before communicating data over the network (130), the data may first be broken into smaller batches (e.g., data packets) so that larger size data can be communicated efficiently. For this reason, the network-enabled subcomponents may break data into data packets. The network-enabled subcomponents may then route each data packet in the network (130) to distribute network traffic uniformly.

In one or more embodiments, the network-enabled subcomponents may decide how real-time (e.g., on the order of ms or less) network traffic and non-real-time network traffic should be managed in the network (130). In one or more embodiments, the real-time network traffic may be high-priority (e.g., urgent, immediate, etc.) network traffic. For this reason, data packets of the real-time network traffic may need to be prioritized in the network (130). The real-time network traffic may include data packets related to, for example (but not limited to): videoconferencing, web browsing, voice over Internet Protocol (VoIP), etc.

While FIG. 1.1 shows a configuration of components, other system configurations may be used without departing from the scope of the embodiments disclosed herein.

Turning now to FIG. 1.2, FIG. 1.2 shows an example cache insertion scenario in accordance with one or more embodiments disclosed herein. The example, illustrated in FIG. 1.2 and described below, is for explanatory purposes only and not intended to limit the scope disclosed herein.

In general, a backup workload is quite deterministic (e.g., in the sense that a user may expect a set of file read/write operations to be performed in order to conduct a corresponding backup process) and there is at least a pattern in file system operations (e.g., create/access a file (F1), write a file (F2), get attributes of a file (F3), readdir (e.g., list a directory (or list each file under a directory entry, by accessing each file's inode) “d1” (in a related directory tree): d1/F1, d1/F2, and d1/F4), read a file (F5), commit/save a file (F2), lookup a file (F6), etc.). Based on this and with the help of contextual hints (where the content of a related inode is analyzed to determine its caching level) (e.g., a type of a performed file system operation to cache an inode of a related file in memory, a number of hard links related to a file, a size of a file, a group identifier of a file, permissions of a file, a timestamp that is indicating when the file was last accessed and modified, (depending on the workload) users (or a group of users) that are performing a specific file system operation (where, based on this hint, sticky cache can be generated), etc.), the data protection module (125) may (i) use/employ a multi-level cache structure, (ii) provide inode cache management (in the memory) (e.g., a process of storing and/or retrieving inodes from a cache to avoid reading and/or writing the inodes from the storage each time the inodes are needed), and (iii) redirect a data item to a related cache tier/level (e.g., Level 1 (L1) cache, L2 cache, L3 cache, etc.) based on the type of the operation. Separately, in one or more embodiments, some operations (e.g., a file rename operation) may not be performed frequently, and, even if these operations are performed frequently, these operations may not be intermixed with the backups.

In one or more embodiments, the data protection module (125) may also perform at least the aforementioned functionalities (a) with the help of any file system operation specific information (as cache hints) and (b) based on an application (e.g., a backup application) that provides cache hints about frequently accessed files and/or directories (e.g., an active directory file system) via extended attributes.

As used herein, the use of “data item” is intended to be broadly construed to encompass, for example, a block, a chunk, file, object, or other grouping of data suitable for storage in the storage (e.g., 135, FIG. 1.1).

As used herein, an “inode” serves as a unique identifier for a specific piece of file system metadata, in which each piece of the metadata describes what one may imagine as a file. In one or more embodiments, one or more inodes may operate on different file systems. An inode key/entry may be used more than once but never by the same file system. Further, since an inode entry has a reference to a content handle (that represents corresponding file data), a user may access the inode entry and read contents/data of a corresponding asset.

As used herein, a “directory entry” is a mapping of a filename to its inode (e.g., information to translate from a filename to an inode and get to the actual file, a directory entry has a reference to a corresponding inode, etc.). For example, a directory entry may specify “filename 1:>inode1”. Thereafter, by following “inode 1” entry (e.g., a unique address of (or a pointer to) “inode 1”), all the permissions, attributes (e.g., size, type, owner, etc.), data/contents of a corresponding asset may be determined. From a different perspective, in most cases, a user may access a file by its filename; however, such filenames are not understood by a kernel (of a corresponding client (e.g., 110A, FIG. 1.1)). To this end, the kernel may identify a file using a corresponding inode (which is unique to that file), in which (i) the inode contains all the data of the file except its identifier/name and the actual data in the file and (ii) such mapping of the filename to its inode is maintained in a corresponding directory entry.

Referring to FIG. 1.2, (i) L1 cache may represent a cache level where inodes (e.g., F1-inode, F2-inode, and F5-inode) that are accessed/used as part of file system operations that have the highest probability of cache hits in the future (e.g., a file read operation, a file write operation, etc., where the related files are expected to be accessed frequently in the future), (ii) L2 cache may represent a cache level where inodes (e.g., F6-inode) that are accessed as part of file system operations that have an average probability of cache hits in the future (e.g., a file access check operation, a file lookup operation, etc., where the related files are expected to be accessed casually in the future), and (iii) L3 cache may represent a cache level where inodes (e.g., F4-inode) that are accessed as part of file system operations that have the lowest probability of cache hits in the future (e.g., a file closing operation, where the related files are expected to be accessed infrequently in the future).

Further, referring to FIG. 1.2 (and FIG. 1.3), in a multi-level caching system/framework, an inode (or an inode entry) may be promoted or demoted between cache levels (e.g., L1 cache-L3 cache) based on the inode's access patterns (e.g., how frequently the inode is accessed) and file system operation types. For example, a file (e.g., F1) may be accessed as part of an open/access operation and, for this reason, the corresponding inode (“F1-inode”) may be kept in L1 cache (as F1 would have a high probability of further cache hit while performing read/write operations). As yet another example, an inode (e.g., “F4-inode”) that was accessed as part of an “readdir” operation may be kept in L3 cache as the data protection module (125) may not expect further usage of the inode in the future.

As yet another example, consider a scenario where an inode was cached to L3 cache and immediately thereafter, a file open/access operation was performed on a corresponding file. In this scenario, the data protection module (125) may promote/move the inode (of the file) from L3 cache to L1 cache. Further, as yet another example, consider a scenario where an inode was cached to L1 cache because of a recent file open operation performed on a related file. In this scenario, as soon as the file is closed, the data protection module (125) may demote/move the inode (of the file) from L1 cache to L2 cache (because the file may be opened again in near future).

In one or more embodiments, a cache level (e.g., L1 cache-L3 cache) may be implemented using any suitable data structure (e.g., a hash table, a splay tree, a single list, etc.). Further, while performing inode cache management, the data protection module (125) may operate in conjunction with any existing mechanism/approach (e.g., the LRU cache approach). For example, to perform cache eviction, the data protection module (125) may apply the LRU approach based on a separate cache list or by traversing all cache entries (where additional two bits may be added to a corresponding cache element (e.g., an inode) to define a cache level that the element belongs to). In this example, if the data protection module (125) is using a doubly linked list to apply the LRU approach (with the help of additional two bits), the data protection module may keep/have separate LRUs for each level of cache. Separately, if the data protection module (125) is traversing each element on a related hash table for inode eviction, the data protection module may use information of each element (e.g., additional two bits of each element) to determine which inodes need to be evicted.

Referring to FIG. 1.2, assume that a “readdir” operation is performed on directory d1 (dir d1). In this case, all the files listed under “dir d1” (e.g., d1/F1, d1/F2, and d1/F4) may be placed in L3 cache. If the file “d1/F1” is opened (e.g., after receiving a request from a user via a client), the data protection module (125) may promote/move “F1-inode” (or “F1-inode” cache entry) from L3 cache to L1 cache. Thereafter, if the file “d1/F1” was removed, the data protection module (125) may demote “F1-inode” from L1 cache to L3 cache or drop “F1-inode” from the cache (or memory). Separately, if another lookup operation is performed for “F6” (e.g., after receiving a request from a user via a client), the data protection module (125) may place/insert “F6-inode” to L2 cache.

Turning now to FIG. 1.3, FIG. 1.3 shows an example cache eviction scenario in accordance with one or more embodiments disclosed herein. The example, illustrated in FIG. 1.3 and described below, is for explanatory purposes only and not intended to limit the scope disclosed herein.

Following the discussion in FIG. 1.2 and referring FIG. 1.3, a “readdir” operation that is performed on “dir d1” may trigger eviction of “F4-inode” (underlined) from L3 cache first (because the data protection module (125) needs to evict an inode from the cache (or memory)). As indicated, the data protection module (125) may perform an inode eviction process from a suitable, lower cache level first before moving up to a suitable, higher cache level in the cache. With this way, the data protection module (125) may ensure that a set of inodes that would most likely be accessed (in the future) is kept in the cache, while a set of inodes that would less likely be accessed (in the future) is evicted from the cache to create space for new inode entries (to the cache).

Separately, in one or more embodiments, on-demand or periodically, the data protection module (125) may perform a cache purge process, in which the data protection module may remove multiple inode entries from a lower cache level (e.g., L3 cache).

Further, since the usage of cache space is important, the data protection module (125) may assign specific space for each cache level (e.g., L1 cache-L3 cache) and, if necessary, may adjust assigned space of a cache level (via move markers in memory). For example, in order to insert additional inodes to L1 cache, the data protection module (125) may increase L1 cache's space by assigning some of the “unused” space that is assigned to L2 cache.

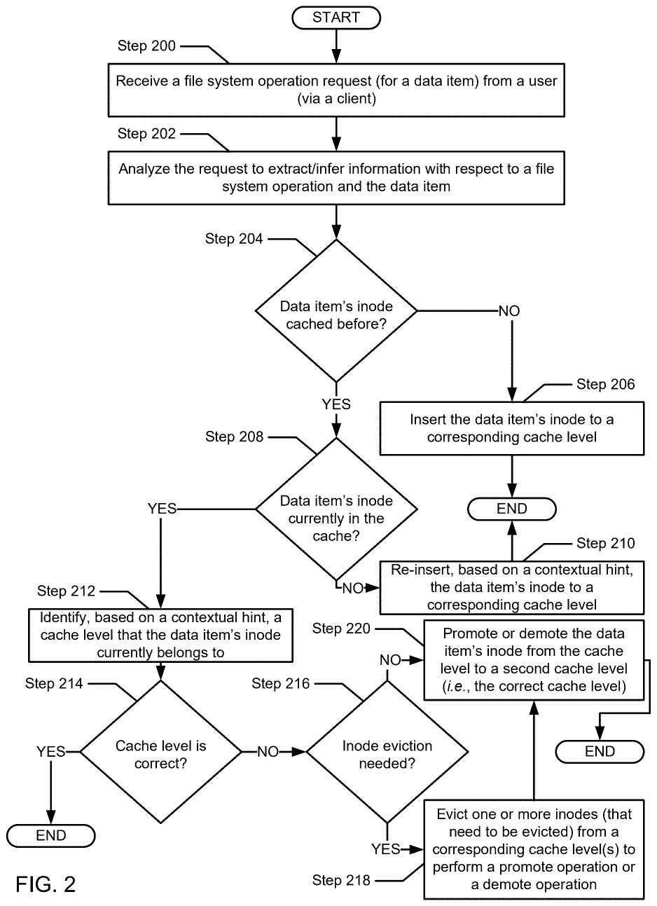

FIG. 2 shows a method for operation based multi-level caching (e.g., in memory) in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 2, the method shown in FIG. 2 may be executed by, for example, the above-discussed manager (e.g., 125, FIG. 1.1). Other components of the system (100) illustrated in FIG. 1 may also execute all or part of the method shown in FIG. 2 without departing from the scope of the embodiments disclosed herein.

In Step 200, the data protection module receives a file system operation request (for a data item (e.g., a file)) from a requesting entity (e.g., a user of a client (e.g., 110A, FIG. 1.1), an administrator terminal, an application, etc.). In one or more embodiments, the user may send the request to access the data item in the storage (e.g., 135, FIG. 1.1).

In Step 202, in response to receiving the request, as part of the request, and/or in any other manner (e.g., before initiating any computation with respect to the request), the data protection module (by employing a set of linear, non-linear, and/or ML models) analyzes the request to extract/infer information with respect to a file system operation that is indicated/specified in the request (or that is in the request) (e.g., a file read operation, a file write operation, etc.) and the data item.

In one or more embodiments, the information may specify, at least, a set of attributes related to the data item (e.g., file system metadata of the data item), a type of the file system operation, a timestamp that is indicating when the file was last accessed and modified, (depending on the workload) a group of users that are performing a specific file system operation, and/or an application that is providing cache hints about frequently accessed files and/or directories via extended attributes. Details of a file system operation are described above in reference to FIG. 1.2-1.3.

In Step 204, based on the information and second information obtained from memory, the data protection module makes a first determination (in real-time or near real-time) as to whether an inode of the data item is cached to the memory previously. Accordingly, in one or more embodiments, if the result of the first determination is YES, the method proceeds to Step 208. If the result of the first determination is NO, the method proceeds to Step 206.

In one or more embodiments, the second information may specify which cache level in the memory includes/hosts which inode cache (e.g., L1 cache hosts “F1-inode”, L2 cache hosts “F6-inode”, etc., see FIG. 1.2), in which an inode cache is memory space of the memory assigned to a corresponding inode.

In Step 206, as a result of the first determination in Step 204 being NO, the data protection module inserts the data item's inode to a corresponding cache level based on, for example (but not limited to): a type of a performed file system operation to cache an inode of a related file in memory, a number of hard links related to a file, a size of a file, a group identifier of a file, permissions of a file, a timestamp that is indicating when the file was last accessed and modified, etc. In one or more embodiments, the method may end following Step 206.

In Step 208, as a result of the first determination in Step 204 being YES, the data protection module makes a second determination (in real-time or near real-time) as to whether the inode (of the data item) is currently cached to the memory. Accordingly, in one or more embodiments, if the result of the second determination is YES, the method proceeds to Step 212. If the result of the second determination is NO, the method proceeds to Step 210.

In Step 210, as a result of the second determination in Step 208 being NO and based on one or more contextual hints (e.g., attributes of a related inode), the data protection module re-inserts the data item's inode to a corresponding cache level. In one or more embodiments, the method may end following Step 210.

In Step 212, as a result of the second determination in Step 208 being YES, the data protection module (by employing a set of linear, non-linear, and/or ML models and based on one or more contextual hints (e.g., attributes of a related inode)) identifies a cache level that the data item's inode currently belongs to (e.g., a first cache level in the memory that the inode was previously cached to). In one or embodiments, the inode may previously be cached to L2 cache (see FIG. 1.2) in the memory in response to a file look up operation (or a file lookup operation), or to L3 cache (see FIG. 1.2) in the memory in response to a “readdir” operation.

In Step 214, based on Step 212 and using the contextual hints to determine the cache level, the data protection module makes a third determination (in real-time or near real-time) as to whether the first cache level is correct. Accordingly, in one or more embodiments, if the result of the third determination is YES, the method may end following Step 214. If the result of the third determination is NO, the method proceeds to Step 216.

In Step 216, as a result of the third determination in Step 214 being NO (e.g., the first cache level is not correct), the data protection module makes a fourth determination (in real-time or near real-time) as to whether an inode eviction in a second cache level (of the memory) is needed. Accordingly, in one or more embodiments, if the result of the fourth determination is YES (e.g., because the cache level is full (or at full capacity)), the method proceeds to Step 218. If the result of the fourth determination is NO, the method proceeds to Step 220.

In Step 218, as a result of the fourth determination in Step 216 being YES (e.g., an inode eviction in a second cache level is needed), the data protection module evicts one or more inodes (that need to be evicted) (e.g., a second inode of a second data item) from a corresponding cache level(s) (of the memory, for example, the second cache level) to perform an inode promote operation or an inode demote operation. In one or more embodiments, the second inode may be an inode of a less frequently accessed data item (in the memory) and the second inode may specify metadata (e.g., file system metadata) of the second data item. Further, the eviction of the second inode may be needed because the second cache level may be at full capacity.

In Step 220, as a result of the fourth determination in Step 216 being NO or based on Step 218 (after the evicting), the data protection module promotes or demotes the inode (of the data item) from the first cache level to the second cache level (i.e., the correct cache level), in order to cache the inode to the second cache level. In one or more embodiments, the method may end following Step 220.

Turning now to FIG. 3, FIG. 3 shows a diagram of a computing device in accordance with one or more embodiments disclosed herein.

In one or more embodiments disclosed herein, the computing device (300) may include one or more computer processors (302), non-persistent storage (304) (e.g., volatile memory, such as RAM, cache memory), persistent storage (306) (e.g., a non-transitory computer readable medium, a hard disk, an optical drive such as a CD drive or a DVD drive, a Flash memory, etc.), a communication interface (312) (e.g., Bluetooth interface, infrared interface, network interface, optical interface, etc.), an input device(s) (310), an output device(s) (308), and numerous other elements (not shown) and functionalities. Each of these components is described below.

In one or more embodiments, the computer processor(s) (302) may be an integrated circuit for processing instructions. For example, the computer processor(s) (302) may be one or more cores or micro-cores of a processor. The computing device (300) may also include one or more input devices (310), such as a touchscreen, keyboard, mouse, microphone, touchpad, electronic pen, or any other type of input device. Further, the communication interface (312) may include an integrated circuit for connecting the computing device (300) to a network (e.g., a LAN, a WAN, Internet, mobile network, etc.) and/or to another device, such as another computing device.

In one or more embodiments, the computing device (300) may include one or more output devices (308), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for operation based multi-level caching, the method comprising:
receiving a file system operation request from a user via a computing device,
wherein the request is received for a data item;
analyzing the request to extract information with respect to a file system operation and the data item;
making a first determination, based on the information and second information obtained from memory, that an index node (inode) of the data item is cached to the memory previously;
making a second determination, based on the first determination, that the inode is currently cached to the memory;
identifying, based on the second determination, a first cache level in the memory that the inode was previously cached to;
making a third determination, based on the identifying and using contextual hints to determine a cache level, that the first cache level is not correct;
making a fourth determination, based on the third determination, that an inode eviction in a second cache level is needed;
evicting, based on the fourth determination, a second inode of a second data item from the second cache level; and
promoting, after the evicting, the inode from the first cache level to the second cache level to cache the inode to the second cache level.

2. The method of claim 1,
wherein the user sends the request to access the data item in storage,
wherein the data item is a file,
wherein the file system operation is a file read operation, and
wherein the inode was previously cached to a level 2 cache in the memory in response to a file look up operation.

3. The method of claim 1,
wherein the user sends the request to access the data item in storage,
wherein the data item is a file,
wherein the file system operation is a file write operation, and
wherein the inode was previously cached to a level 3 cache in the memory in response to a read directory operation.

4. The method of claim 1, wherein the eviction of the second inode is needed because the second cache level is at full capacity.

5. The method of claim 4, wherein the second inode is an inode of a less frequently accessed data item.

6. The method of claim 1, wherein the information specifies a set of attributes related to the data item, a type of the file system operation, a timestamp that indicates when the data item was last accessed, a group of users that performs a second file system operation depending on a workload, and an application that provides a cache hint about frequently accessed data items.

7. The method of claim 1,
wherein the second information specifies which cache level in the memory comprises which inode cache,
wherein an inode cache is a memory space of the memory assigned to the second inode, and
wherein the second inode specifies metadata of the second data item.

8. The method of claim 1, wherein the first cache level is implemented using a hash table or a splay tree.

9. A method for operation based multi-level caching, the method comprising:
receiving a file system operation request from a user via a computing device,
wherein the request is received for a data item;
analyzing the request to extract information with respect to a file system operation and the data item;
making a first determination, based on the information and second information obtained from memory, that an index node (inode) of the data item is cached to the memory previously;
making a second determination, based on the first determination, that the inode is currently cached to the memory;
identifying, based on the second determination, a first cache level in the memory that the inode was previously cached to;
making a third determination, based on the identifying and using contextual hints to determine a cache level, that the first cache level is not correct;
making a fourth determination, based on the third determination, that an inode eviction in a second cache level is not needed; and
promoting, based on the fourth determination, the inode from the first cache level to the second cache level to cache the inode to the second cache level.

10. The method of claim 9,
wherein the user sends the request to access the data item in storage,
wherein the data item is a file,
wherein the file system operation is a file read operation, and
wherein the inode was previously cached to a level 2 cache in the memory in response to a file look up operation.

11. The method of claim 9,
wherein the user sends the request to access the data item in storage,
wherein the data item is a file,
wherein the file system operation is a file write operation, and
wherein the inode was previously cached to a level 3 cache in the memory in response to a read directory operation.

12. The method of claim 9, wherein the information specifies a set of attributes related to the data item, a type of the file system operation, a timestamp that indicates when the data item was last accessed, a group of users that performs a second file system operation depending on a workload, and an application that provides a cache hint about frequently accessed data items.

13. The method of claim 9,
wherein the second information specifies which cache level in the memory comprises which inode cache,
wherein an inode cache is a memory space of the memory assigned to the second inode, and
wherein the second inode specifies metadata of the second data item.

14. The method of claim 9, wherein the first cache level is implemented using a hash table or a splay tree.

15. A method for operation based multi-level caching, the method comprising:
receiving a file system operation request from a user via a computing device, wherein the request is received for a data item;
analyzing the request to extract information with respect to a file system operation and the data item;
making a first determination, based on the information and second information obtained from memory, that an index node (inode) of the data item is cached to the memory previously;
making a second determination, based on the first determination, that the inode is currently cached to the memory;
identifying, based on the second determination, a first cache level in the memory that the inode was previously cached to;
making a third determination, based on the identifying and using contextual hints to determine a cache level, that the first cache level is not correct;
making a fourth determination, based on the third determination, that an inode eviction in a second cache level is needed;
evicting, based on the fourth determination, a second inode of a second data item from the second cache level; and
demoting, after the evicting, the inode from the first cache level to the second cache level to cache the inode to the second cache level.

16. The method of claim 15,
wherein the user sends the request to access the data item in storage,
wherein the data item is a file,
wherein the file system operation is a read directory operation, and
wherein the inode was previously cached to a level 2 cache in the memory in response to a file look up operation.

17. The method of claim 15,
wherein the user sends the request to access the data item in storage,
wherein the data item is a file,
wherein the file system operation is a file look up operation, and
wherein the inode was previously cached to a level 1 cache in the memory in response to a file write operation.

18. The method of claim 15, wherein the eviction of the second inode is needed because the second cache level is at full capacity.

19. The method of claim 18, wherein the second inode is an inode of a less frequently accessed data item.

20. The method of claim 15, wherein the information specifies a set of attributes related to the data item, a type of the file system operation, a timestamp that indicates when the data item was last accessed, a group of users that performs a second file system operation depending on a workload, and an application that provides a cache hint about frequently accessed data items.
